(19) United States
(12) Patent Application Publication
(10) Pub. No.: US 2007/0123343 A1
(43) Pub. Date: May 31, 2007

(54) Reel type game machine

(76) Inventor: Haruo Inoue, Tokyo (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/492,935

(22) Filed: Jul. 26, 2006

(30) Foreign Application Priority Data
Nov. 28, 2005 (JP) 2005-341629

(51) Int. Cl. A63F 13/00

(52) U.S. Cl. 463/20; 463/30

(57) ABSTRACT

A game machine which can announce beforehand or notify of a prize mode with a mechanical means. In the reel type game machine provided with the control part which controls a drive source to be able to determine a prize mode in the pattern indication portion of the inside reel via the visibility of the outside reel, the pattern indication portion of the perimeter of the outside reel is the sign for production which announces beforehand or notifies of the prize mode of the inside reel, and the control part controls the inside and outside source of a drive only for a reel after starting a game according to the prize mode determined by the lottery of the random number generation part, respectively to continue the game concerned by the inside reel, expressing the sign for production to the display window of a game machine.

### REFERENCE TO FOREIGN PATENTAPPLICATION

This application is based on Japanese Patent Application 2005-341629 filed on 28 Nov. 2005, upon which priority is claimed.

### BACKGROUND OF THE INVENTION

1. Field of the Invention

This invention relates to game machines, such as slot machines or pachinko machines of the type employing symbols on a mechanical outside reel and an inside reel in the performance of the game.

2. Description of the Prior Art

Japanese patent document JP 4-114676 A discloses a game (slot machine) in which the inside reel and the outside reel are made into a dual structure, and the reels are driven to rotate individually with the driving force of the exclusive source of a drive, respectively. When the outside reel and the inside reel stop, respectively, a prize mode is determined by combining symbols on the inside and outside reels.

That is, the slot machine of this reference document rotates two or more reels at the back of a symbol display window, and when each reel stops, the existence of a prize winning symbol is decided with the combination of the symbols which appeared in the symbol display window.

The slot machine comprises an outside reel on which is arranged two or more symbols on a transparent reel object, and an inside reel on which a symbol which is rotated by an inner side of this outside reel, and having its perimeter observed through the outside reel.

Since the above-mentioned features of this reference are essentially the same as that of the present invention (same applicant, same inventor), FIGS. 11 and 12 are employed to explain this reference and the fundamental composition (conventional technology) of a slot machine.

Thus, in FIG. 11, the slot machine, designated generally by reference number 1, employs, three display windows 2, 3, and 4 which are formed in base plate 1a. A first reel 5, second reel 6, and third reel 7 are allocated behind base plate 1a.

The pattern indication portion (symbol also containing a blank symbol) given to the perimeter of each reels 5, 6, and 7 can be recognized visually from the display windows 2, 3, and 4, respectively.

Namely, when a symbol is arranged by the first˜third reels 5˜7 in a lengthwise direction and all the reels 5˜7 stop, from symbol display windows 2˜4, every three pieces, therefore a total of nine symbols are observed from the outside for every reel.

Lines 8 indicate two or more possible prize-winning alignments of the symbols. These winning-a-prize lines 8 turn into an effective line for deciding the combination of a symbol about the game, when each reels 5˜7 stop.

After an injection of coin in coin slot 9 and the start lever 10 is operated, the manner in which the reels 5, 6 and 7 rotate all at once, and in which the game is performed is common knowledge. For example, when each reels 5, 6, and 7 stop, the existence of winning a prize is decided with the combination of the symbol which appeared in display windows 2, 3, and 4. Stop buttons as the input part (stop signal) are arranged below reels 5, 6 and 7, respectively, and 14 is a coin saucer.

FIG. 12 shows the composition of the first reel 5, it being understood that reels 6 and 7 are also the same composition as reel 5. Thus, first, second and third reels 5, 6 and 7 comprise the outside reel and the inside reel, respectively. In FIG. 12, an outside reel 5a has a reel object of the outside reel 15 which consists of a transparent resin material.

Two or more patterns (symbol), such as “1BAR”, “3BAR”, a “star”, “7”, and a “cherry”, are arranged on the perimeter of the reel object of the outside reel 15.

On the other hand, an inside reel 5b has a reel object of the inside reel 16 which consists of an opaque resin material.

Two or more patterns (symbol) are arranged on the perimeter of this inside reel 5b as well as the outside reel 5a.

Adapter plates or hubs 15a, 16a of the inside and outside reels, respectively each have two or more connecting arms or spokes connecting the adapter plates 15a and 16a to the outside and inside reel 15 and 16, respectively.

The outside reel 15 and the inside reel 16 are rotated individually by a drive controlled by the control part which is not illustrated.

Therefore, when the reel object of the outside reel 15 and the reel object of the inside reel 16 stop, respectively, a prize mode can be determined combining an inside and outside symbol.

Since the slot machine 1 indicated to reference document can combine the pattern (symbol) provided in the inside reel and the outside reel of dual structure, respectively, it has the advantage that various prize modes (diversification of combination) can be planned.

However, the reel of dual structure is not used for another purpose (in order to announce beforehand or notify of the existence of a prize mode).

When added, the conventional game machine used the inside reel and the outside reel as “a means which determines the existence of winning a prize, and a dividend.

By the way, in the slot machine, “a means to announce beforehand or notify of the existence of a prize mode to the vision of a player” was chiefly performed by the “electric means” after the start of a game.

A classic example is shown in Japanese patent document JP 5-80235 B which discloses a slot machine comprising:

(A) Two or more drums in which two or more patterns are arranged on the peripheral surface,

(B) A drive motor made to drive and suspend each drum individually,

(C) A lottery means which answers that the drive motor carries out simultaneous starting of each drum, and performs a lottery, and

(D) Control means stopping which controls the stop operation of each drum by the drive motor so that the specific pattern array for making it shift to a bonus game gathers on effective stopping lines, when the lottery by the lottery means hits.

When a game begins, since it is under control of the internal processing of a computer whether the lottery by a lottery means hit in the game concerned (when great success for CPU to shift to a bonus game from a random number circuit has been pulled→ did the flag stand or not?), if this is not reported outside by a certain method, a person playing the game cannot know.

If it adds, the game person cannot check the pattern array or warning sign by sight as to whether the specific pattern array gathered on effective stopping lines, and the existence of a possibility of shifting to a bonus game, if all drums do not stop.

Then, when CPU has pulled one of the prize modes from the random number circuit after a game start, it is (a case where a lottery hits).

The control part of reference document 2 controls informing means, such as a lamp, a loudspeaker, and a background, to emit sound, in order to blink a noticing lamp in order to appeal to a game person's vision, or (and) to appeal to a game person's hearing.

Thus, the matter which controls an informing means by the control part after a game start, and announces beforehand or notifies a game person of the existence of a prize mode with a lamp or a loudspeaker (electric means) is publicly known.

However, the matter which announces beforehand or notifies of the existence of a prize mode with a mechanical means (for example, indicating equipment which comprised dual structure of the inside reel and the outside reel) does not exist.

### SUMMARY OF THE INVENTION

An object of the present invention is to provide means to announce beforehand or notify of the existence of a prize mode with a mechanical means (reel).

Another object to announce beforehand or notify of a prize being clearly won to a game person's vision.

A further object is to enable a person playing the game to know the contents of the prize mode whether a dividend is high or it is low, according to the kind of sign for production of the outside reel.

The reel type game machine of the present invention having the input part the storage parts store, the inside reel and an outside reel which have a pattern indication portion which can be recognized visually via a display window of a game machine, the source of a drive only for a reel which rotates these inside and outside reels, respectively, and the control part which controls the source of a drive, respectively to be able to determine a prize mode in the pattern indication portion of the inside reel through the outside reel in which the pattern indication portion of the perimeter of the outside reel is a sign for production which announces beforehand or notifies of the prize mode of the inside reel, and wherein the control part controls the source of a drive only for reel of the inside reel and the outside reel after starting a game according to the prize mode determined by the lottery of a random number generation part, respectively to continue the game concerned by the inside reel, expressing the sign for production to the display window.

In the above-mentioned composition, the control part includes controlling the source of a drive of the inside reel, stopping the outside reel by the sign for production corresponding to the prize mode determined by the lottery of the random number generation part, and displaying of this indicator to the view of a player.

Here, the sign for production (production pattern) means information required for the production of a geometric figure, a number, a character, a sign, a pattern, the character, an illustration, a photograph, etc.

The present invention is understood to encompass embodiments which include all or only a portion of the above objects, features and advantages which, unless recited in claims defining the present invention, are understood not to limit interpretation of such claims.

### BRIEF DESCRIPTION OF THE DRAWINGS

The above, and other objects, features and advantages of the present invention will become apparent from the following description read in conjunction with the accompanying drawings, in which:

FIG. 1 is a front elevation view of a game machine embodying the invention;

FIG. 2 is an enlarged fragmentary view of a portion of the machine shown in FIG. 1 at the time of a stop;

FIG. 3 is a perspective view showing the structure of an inside and outside reel;

FIG. 4 is a schematic view showing the relation between the production pattern and a prize mode;

FIG. 5 is a longitudinal-section view through the reels of the machine;

FIG. 6 is a block diagram showing electric composition;

FIG. 7 is a flow chart of a 1st embodiment;

FIGS. 8 (a) and (b) are supplementary information figures about the operation of an inside reel and outside reel;

FIG. 9 is a schematic view showing an example of winning a prize at the time of an inside reel stop;

FIG. 10 is a flow chart of a 2nd embodiment;

FIG. 11 is a view similar to FIG. 1, view showing an example of a prior art game machine; and

FIG. 12 is a view similar to FIG. 3, view showing the structure of a prior art inside and outside reel.

### DESCRIPTION OF THE PREFERRED EMBODIMENTS

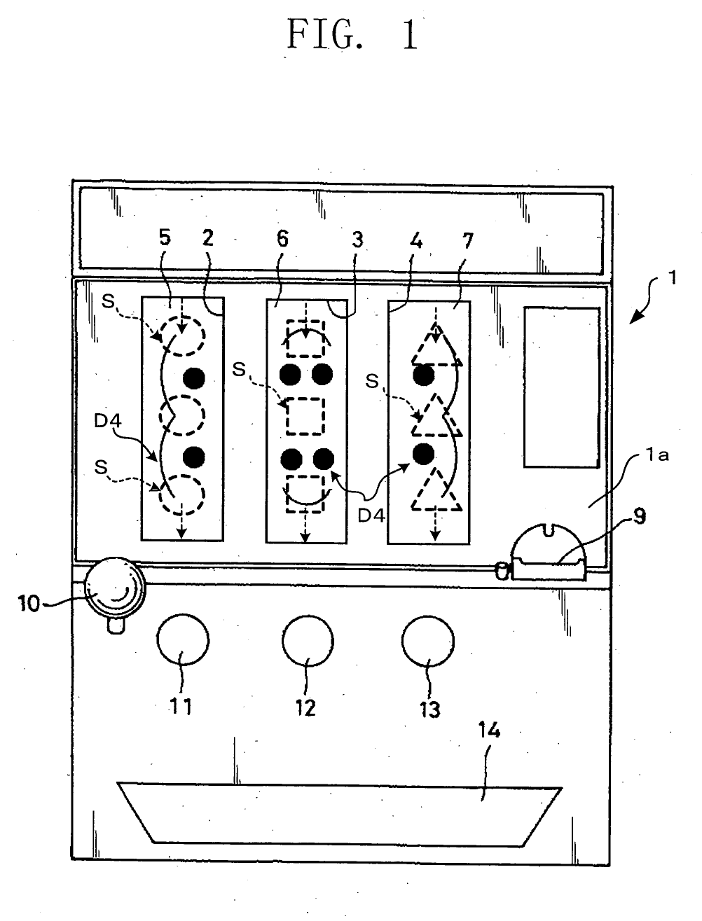

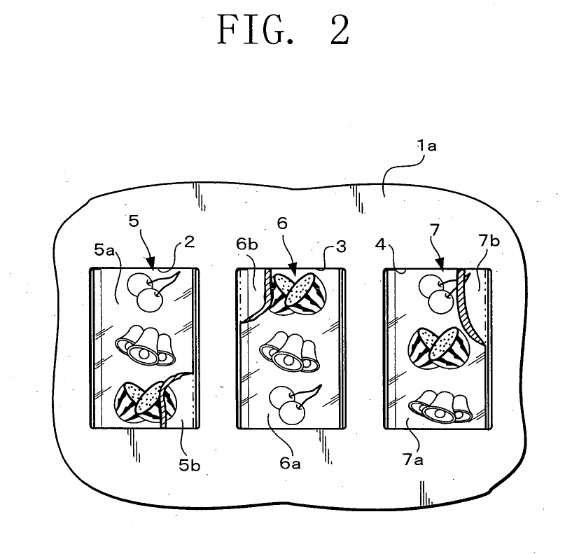

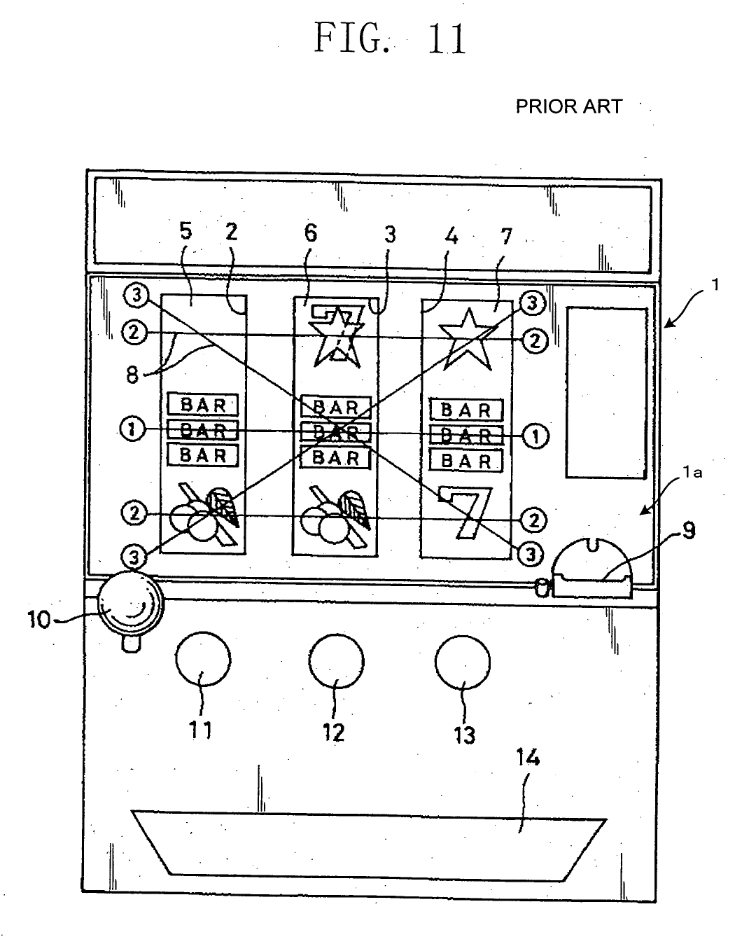

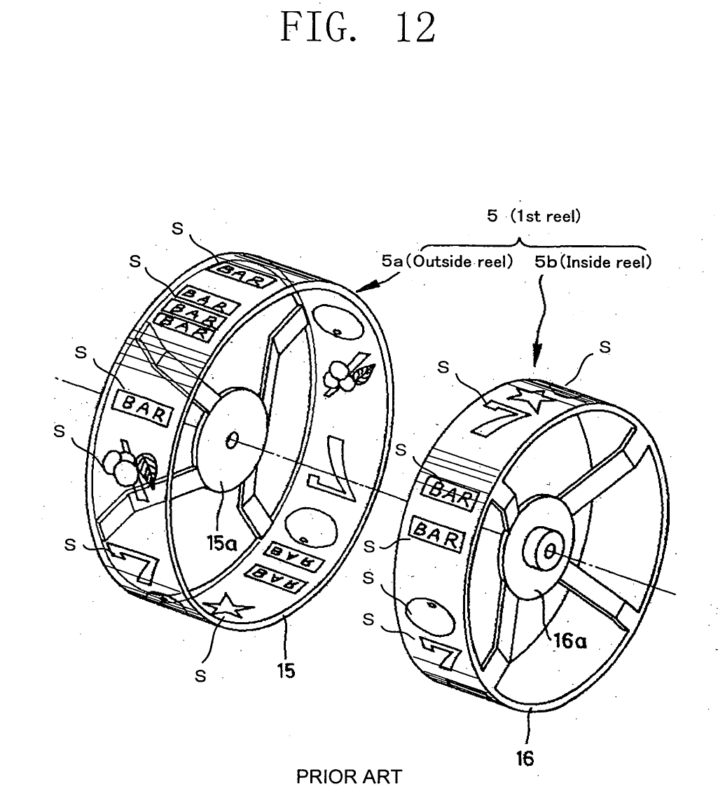

In FIGS. 1 through 10, 1 is a slot machine, 1a is the base plate, 2, 3, and 4 are production and the display window for symbols, 5 is the 1st reel, 6 is the 2nd reel, 7 is the 3rd reel, 9 is a coin slot, 10 is the input part for input signals, 11, 12, and 13 are the input parts for stop signals, 14 is a coin saucer, 5a is the outside reel, 15 is a reel object of the outside reel, 15a is an adapter plate of the outside reel, 5b is the inside reel, 16 is a reel object of the inside reel, 16a is an adapter plate of the inside reel. These reference members are the same as those used in FIGS. 11 and 12 representing the prior art.

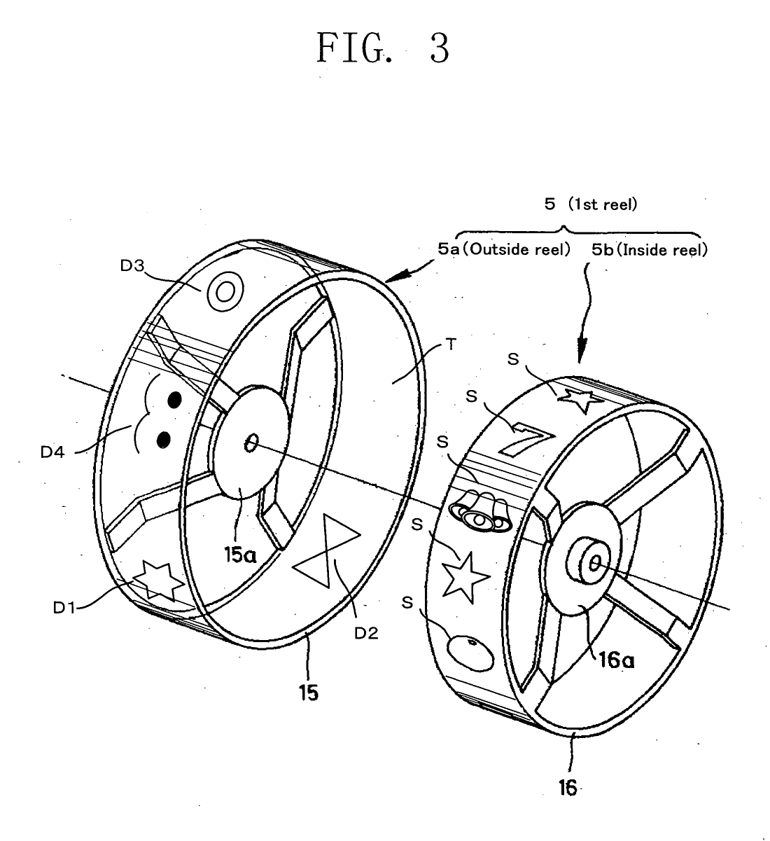

Features of the present invention can be understood if FIG. 3 and FIG. 12 are compared. That is, two or more symbols S, such as “1BAR”, “3BAR”, a “star”, “7”, and a “cherry”, are arranged by the pattern indication portion (perimeter) of conventional outside reel 5a of FIG. 12. The symbol S forms one of the prize modes combining symbol S of the outside reel, and symbol S of an inside reel. When it adds, the pattern of the perimeter of outside reel 5a is an indicator for creating “a synthetic symbol” on an effective line when an inside and outside reel stops simultaneously.

On the other hand, the geometric figures for production (a star map form, a view of symmetrical parts, a double circle figure, a curve, an eyeball figure, etc.), D1, D2, D3, and D4 are given to the zone where the pattern indication portion (perimeter) of outside reel 5a of the present invention of FIG. 3 was divided, respectively.

These geometric figures are the sign for production which announces beforehand or notifies of the existence of the prize mode of the inside reel.

Stated differently although two or more sign for production D1, D2, D3, and D4 are arranged via transparent area of a non-sign T by the pattern indication portion (perimeter) which can be seen through outside reel 5a, an electric means and information control means, such as a lamp, a loudspeaker, and a background, are realized mechanically.

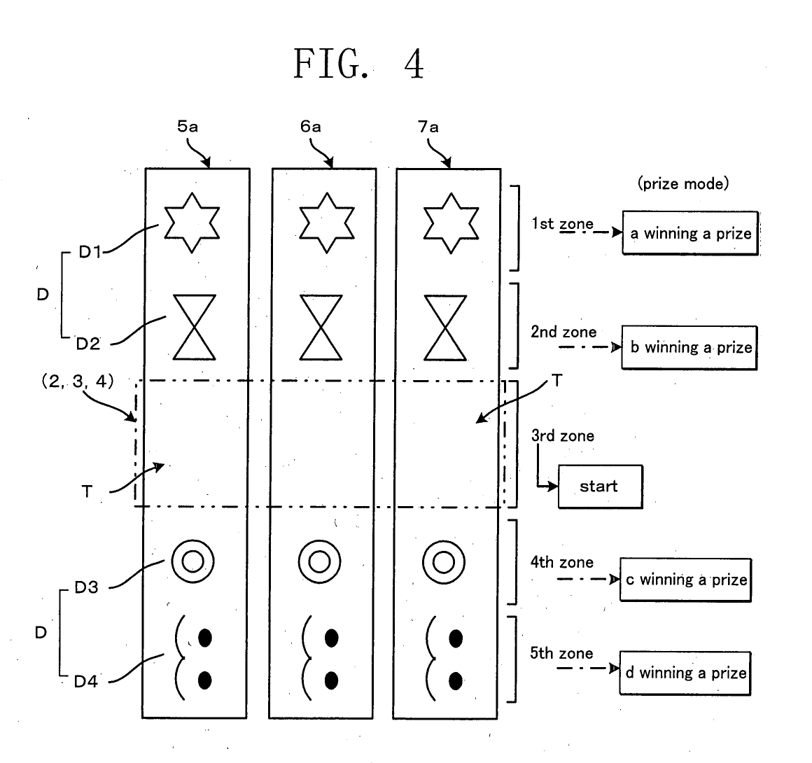

Therefore, a prize-winning condition is chiefly performed as symbol S of inside reel 5b. As for the sign for production of outside reel 5a, it is completely unrelated to the existence of winning a prize, or a dividend. This point is different from conventional outside reel 5a. Referring to FIG. 4, the sign for production D of the pattern indication portion of outside reels Sa, 6a, and 7a is explained. FIG. 4 shows the pattern indication portion of outside reels 5a, 6a, and 7a on an enlarged scale. The pattern indication portion (perimeter) has established two or more zones in the circumferential direction, respectively.

A division zone is a portion of the transparent area of a non-sign T positioned in each display windows 2, 3, and 4, respectively at the time of a game start, and the production portion D (direction) to which two or more kinds of sign for production (production pattern) D1, D2, D3, and D4 which may appear in the display windows 2, 3, and 4 after a game start was given, respectively.

Here, the sign for production (for example, star map form) of D1 is the 1st zone. A sign for production d1 of this 1st zone corresponds to “a winning a prize” of symbol S of inside reel 5b. The sign for production (for example, view of symmetrical parts) of D2 is the 2nd zone. Sign for production D2 of this 2nd zone corresponds to “b winning a prize” of symbol S of inside reel 5b. The sign for production (for example, double circle figure) of D3 is the 4th zone. Sign for production D3 of this 4th zone corresponds to “c winning a prize” of symbol S of inside reel 5b. The sign for production (for example, figure of a wave and an eyeball) of D4 is the 5th zone. Sign for production D of this 5th zone corresponds to “d winning a prize” of symbol S of inside reel 5b. Therefore, transparent area of a non-sign T between the 2nd zone (sign for production D2) and the 4th zone (sign for production D3) is equivalent to the 3rd zone.

As mentioned above, the 3rd zone of outside reels 5a, 6a, and 7a is positioned in each display windows 2, 3, and 4 of game machine 1 at the time of a game start. At this example, two or more kinds of sign for production constitutes “the indication of one prize mode” from combination of two or more outside reels 5a, 6a, and 7a arranged in parallel by right and left. In the inside of two or more kinds of sign for production, the indicator (for example, D4) meaning the case where a dividend is high, and the indicator (for example, D1) meaning the case where a dividend is low are contained.

The prize mode of the inside reel is now explained: it does not limit in particular for the prize mode of the inside reel. For example, it is the indication of the following modes which can obtain specific profits etc for a person playing the game:

The number of specific patterns 7, 7, and 7 gathered on the effective line,

The specific pattern appeared in the specific part,

Two or more specific patterns appeared in the parallel state in the specific part,

One or more specific patterns appeared within the limits of specification, and

The specific pattern appeared in the specific part within the limits of the fixed number of games.

It is the indication in the state where it applied to them correspondingly.

In this example, at least one sign for production D of the pattern indication portion of outside reels 5a, 6a, and 7a is related with at least one of the prize modes of these of the inside reel.

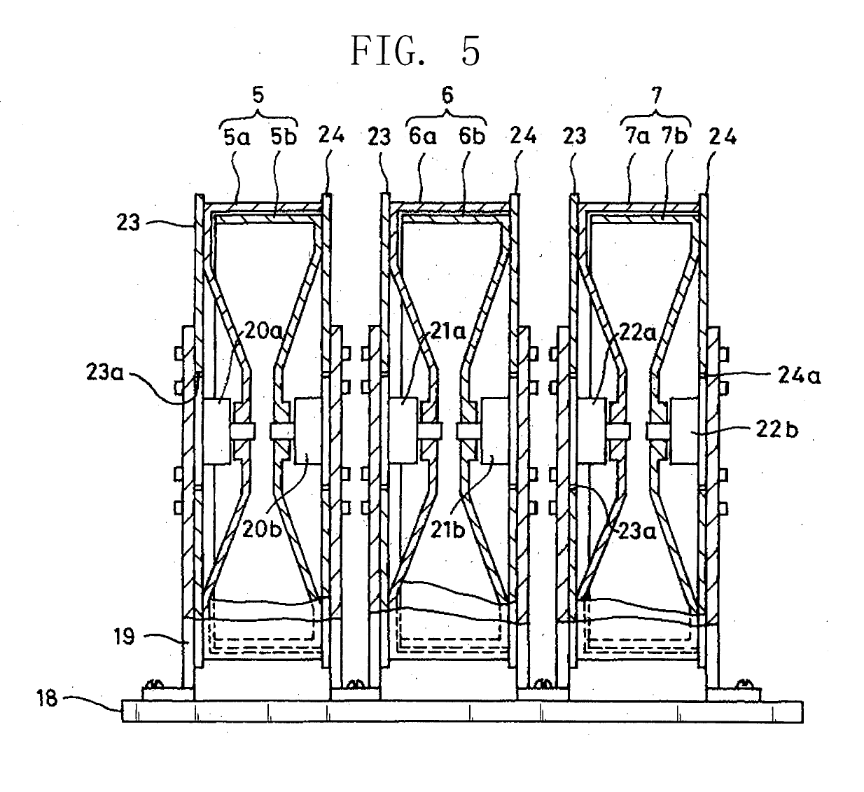

Referring to FIG. 5, the mounting structure of the drive sources and a reel shows an example of the 20a, 20b, 21a, 21b, 22a, and 22b and the reels 5, 6, and 7 are illustrated. A base board 18 is fixed to the back of base plate la of game machine 1. Any shape of base board 18 may be used. Bracket 19 for reel support is mounted to this base board 18. Drive sources (stepping motors) 20a, 20b, 21a, 21b, 22a, and 22b are mounted on the bracket 19 via rotation supporting plates 23 and 24 of one pair of right and left, respectively. Outside reels 5a, 6a, and 7a reel are fixed to the axis of the stepping motors 20a, 21a, and 22a, respectively. On the other hand, inside reels 5b, 6b, and 7b are fixed to the stepping motors 20b, 21b, and 22b, respectively. Therefore, each reel is rotated individually by the driving force of the source of a drive for exclusive use, respectively.

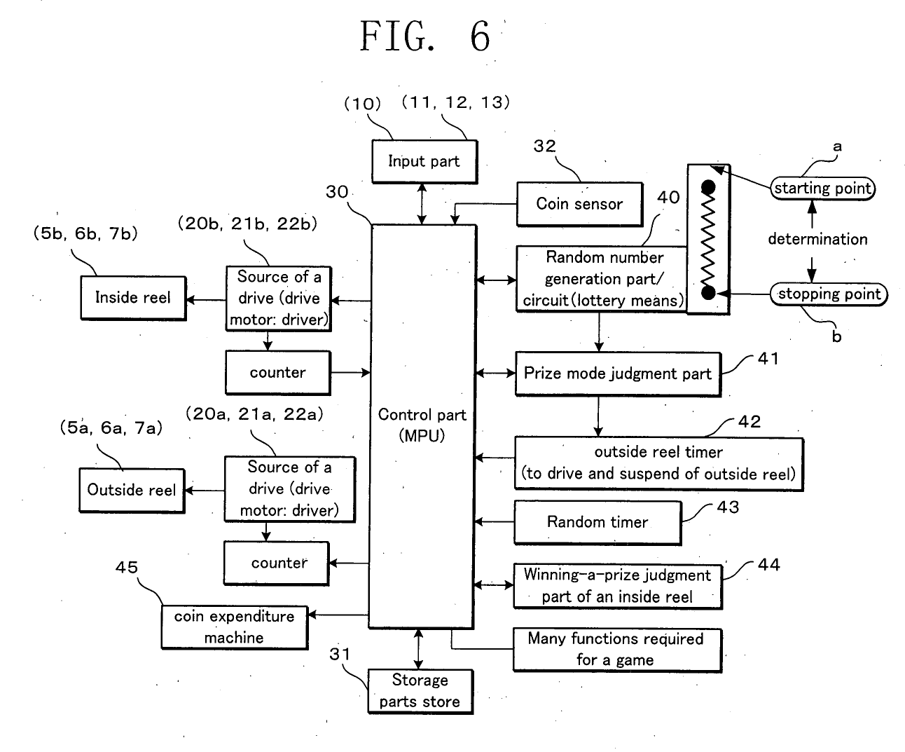

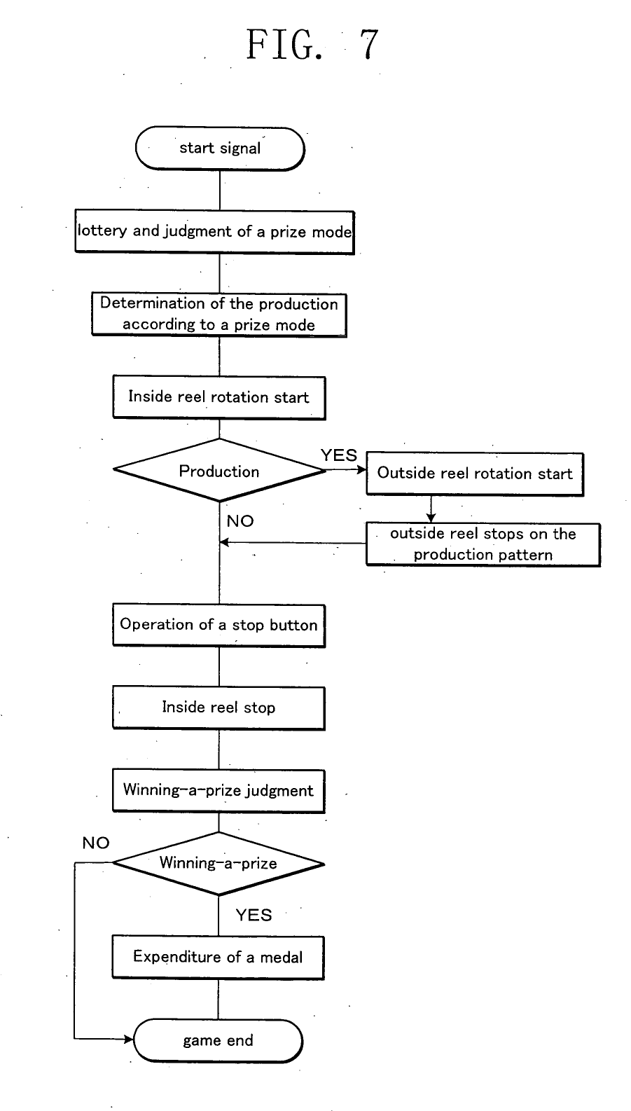

The electric components of a game machine are shown in FIG. 6 as a block diagram while FIG. 7 shows an example of a flow chart for the game machine.

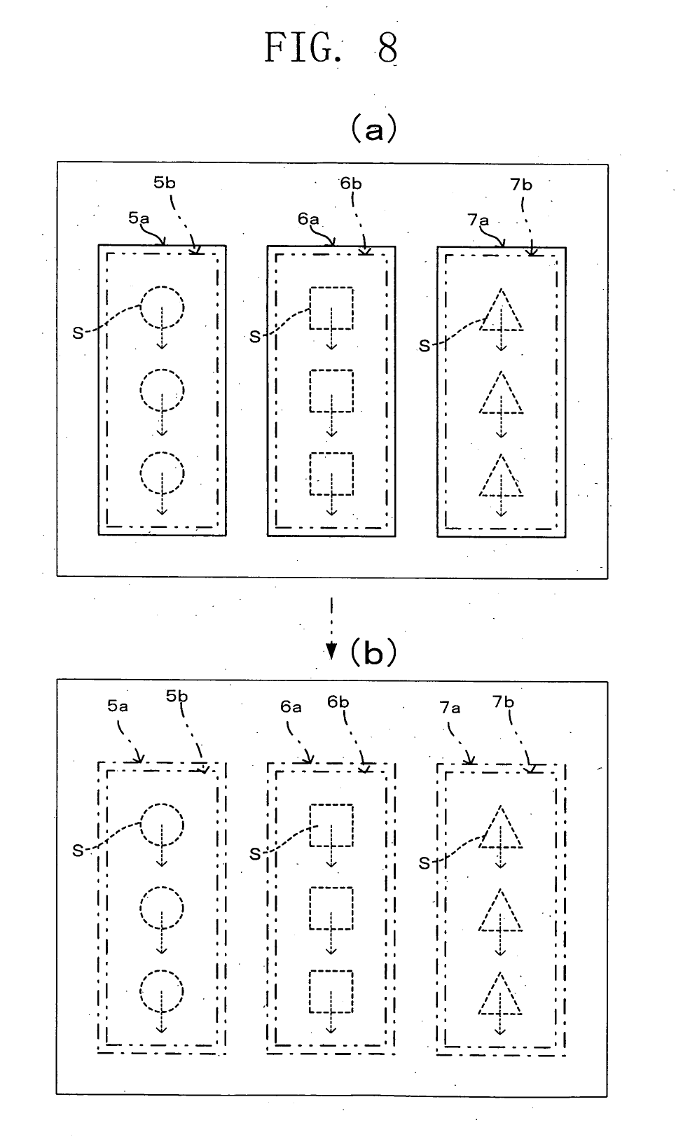

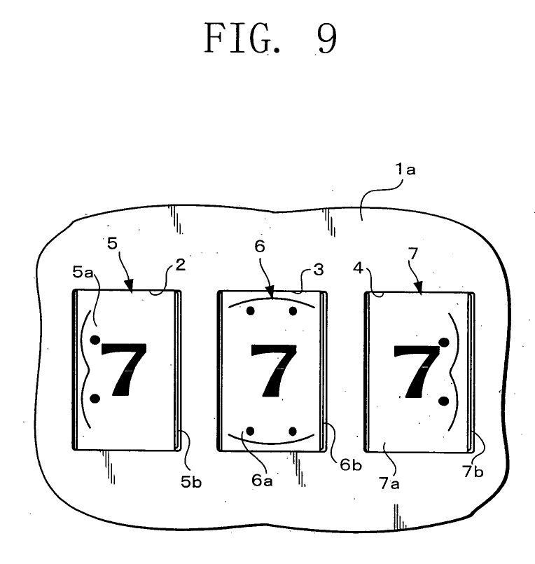

Referring to FIG. 8 (a), (b), FIG. 1 and FIG. 9, the portion used as the feature of the control part of the present invention is explained. Control part (microprocessor unit MPU) 30 performs a game according to the sequence program stored in storage parts store 31. Coin sensor 32 detects the number of sheets of the coin thrown in from coin slot 9, and inputs it into MPU 30, and, thereby, the validation number of a winning-a-prize line is determined. If input part 10 is operated, a start signal generating part (with no illustration) will input a start signal into MPU 30 which rotates the reels 5˜7 by the input of this start signal. Rotation of reels 5˜7 is started when MPU 30 supplies a clock pulse to each source of a drive (drive motor: driver).

The driver for each source drive receives the clock pulse from MPU 30, and supplies a driving pulse to each stepping motors 20a˜22b corresponding to the frequency. Stepping motors 20a˜22b rotate a fixed angle for every driving pulse supplied.

Calculation of the driving pulse outputted from the driver is carried out at the counter. Whenever stepping motors 20a˜22b pass through a rotational zero position to the reset terminal of the counter, a reset pulse is inputted into it, and a discrete value is cleared by “0” each time.

Therefore, the discrete value of each counter is a value corresponding to the rotation angle within 1 rotation of a stepping motor. When the zone of the perimeter of each reels 5a˜7b, the arrangement order of a symbol, and stepping motors 5a˜7b stop exactly in a zero position.

Since the kind of transparent non-indicator portion T and sign for production D which appear in the center of display windows 2˜4, and symbol S is known beforehand, non-indicator portion T which has stopped within each display window 2˜4 based on the discrete value of a counter, sign for production D, and symbol S can be specified.

Now, as shown in FIG. 6, if a start signal is acquired from input part 10, control part MPU 30 will access random number generation part (circuit) 40, and will perform the lottery and determination of a prize mode. Random number generation part 40 has starting point a and stopping point b. In this example, the lottery and determination of a prize mode are performed between starting point a and stopping point b. Of course, it is not the limited requirements for an invention to make the lottery and determination of a prize mode at the start time. MPU 30 may make the lottery and determination of a prize mode, after controlling each source of a drives 20b, 21b, and 22b so that inside reels 5b˜7b rotate.

In this example, just before each source of a drives 20b, 21b, and 22b start, the lottery and determination of a prize mode are performed.

Therefore, irrespective of whether one of the prize modes is determined, MPU 30 controls each source of a drives 20b, 21b, and 22b so that inside reels 5b˜7b rotate after the stopping point b.

When the random number generation part 40 has pulled one of the prize modes, prize mode judgment part 41 controls each source of a drives 20a, 21a, and 22a so that outside reels 5a˜7a rotate.

An outside reel timer 42 starts outside reels 5a˜7a, when prize mode judgment part 41 judges with “the games concerned are those with a prize mode”, and outside reels 5a˜7a are stopped all at once to the timing to which the sign for production corresponding to the prize mode concerned appears in display windows 2, 3, and 4. Even if MPU 30 acquires an outside reel stop signal from outside reel timer 42, it continues rotating inside reels 5b˜7b. That is, MPU 30 controls the source of a drive of each inside reels 5b˜7b until there is a stop signal irrespective of whether outside reels 5a˜7a stop.

Referring to FIG. 8 and FIG. 1, the above-mentioned explanation is further explained. In FIG. 8 (a), outside reels 5a˜7a are in that idle states, although inside reels 5b˜7b are preceding and rotating after stopping point b of random number generation part 40.

When outside reels 5a˜7a have stopped, as mentioned above, sign for production D4 does not appear in display windows 2, 3, and 4. On the other hand, FIG. 8 (b) shows the case where random number generation part 40 has pulled one of the prize modes. At this time, outside reels 5a˜7a of an imaginary line also mean having started rotation.

Next, FIG. 1 shows the that, after starting a game, when one of the prize modes exists in the game concerned via random number generation part 40, MPU 30 controls each source of a drives 20b, 21b, and 22b of the inside reel, respectively to continue the game concerned by inside reels 5b˜7b, expressing one of the sign for production (for example, great success D4) to display windows 2, 3, and 4. Since the outside reel is transparent at this time, while not affecting the visibility of the inside reel, the hope for winning a prize increases for a person playing the game. Sign for production D4 shown as the solid line of FIG. 1 means that outside reels 5a˜7a have stopped.

On the other hand, the imaginary line of the circular, quadrangle, triangle, and arrow type on expedient means the state where symbol S of inside reels 5b˜7b is changed. Random timer 43 inputs the stop signal over inside reels 5b˜7b into MPU 30. Input parts 11, 12, and 13 make it generate, respectively, and input an inside reel stop signal into MPU 30. Therefore, MPU 30 stops rotation of inside reels 5b˜7b in response to an inside reel stop signal. Winning-a-prize judgment part of an inside reel 44 judges whether the combination of the symbol on the validated winning-a-prize line corresponds to winning a prize, after rotation of inside reels 5b˜-7b stop. The kind of symbol stopped on a winning-a-prize line is discriminable corresponding to the discrete value of a counter. And if a prize (for example, 7.7.7) is won as a result of this winning-a-prize judging as shown in FIG. 9, coin expenditure machine 45 will operate by the invitation from MPU 30, and will pay out the dividend coin of number of sheets according to the role of winning a prize.

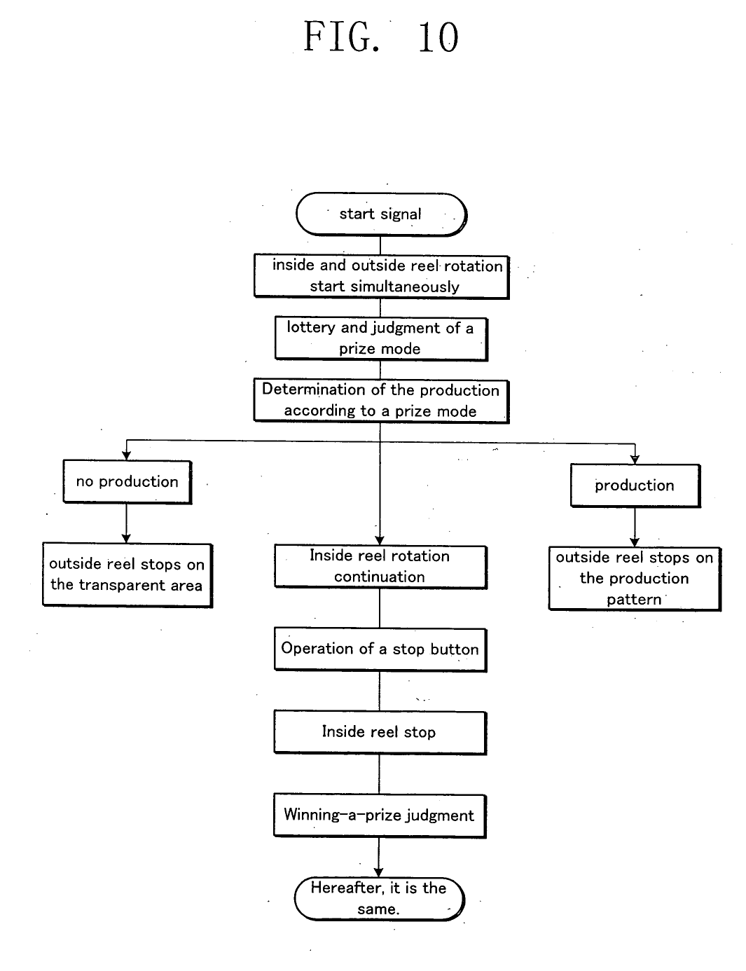

FIG. 7 is a flow chart of the 1st embodiment, and, on the other hand, FIG. 10 is a flow chart of the 2nd embodiment. These figures show the difference at the inside-and-outside reel's starting time. In the first embodiment, the point of starting when inside and outside reels differ, and the point of already being decided about the existence (existence of a production indication) of a prize mode before an inside and outside reel started. In the 2nd embodiment, the point that an inside and outside reel starts at a simultaneous point, and the point of being decided about the existence of a prize mode after an inside and outside reel starts. These differences are not a non-essential matter of the invention. It is a very minor difference matter in which a person skilled in the art can do a design variation suitably about a flow chart. Since it is not necessary about the prize mode of the inside reel to enumerate all publicly known matters, detailed explanation has been omitted. Although a slot machine is made into an example and explained by this example, of course, it is applicable also to the display method of pachinko, and the display method of other game machines, for example.

As set forth above, the advantages of the present invention are as follows:

(1) It can announce beforehand or notify of the existence of a prize mode with a mechanical means (reel).

(2) It can announce beforehand or notify of a prize of a game person's vision being clearly won via the display window of the game machine on a game person's vision.

(3) In a game, the contents of the prize mode (a dividend is high and low) can be known according to the kind of sign for production of the outside reel.

(4) It is not necessary to improve the conventional inside and outside reel.

1-5. (canceled)

6. In a reel type game machine having an input part, a storage parts store, at least one inside reel and at least one outside reel each having a pattern indication portion on its outer periphery which can be recognized visually via a display window of the game machine, a drive means for driving each said inside and outside reel for rotation respectively, a random number generating part, and a control part which controls said drive means respectively to be able to determine a prize mode in said pattern indication portion of said inside reel via the visibility of said outside reel, the improvement wherein
the pattern indication portion of the perimeter of the outside reel comprises a sign for production which announces beforehand or notifies of the prize mode of the inside reel; and
wherein the control part controls said drive means to drive the inside reel and outside reel after starting a game according to the prize mode determined by the lottery of the random number generation part, respectively to continue the game concerned by the inside reel, expressing the sign for production to the display window.

7. The reel type game machine according to claim 6, wherein said control part controls said drive means of said inside reel, and stopping said outside reel by said sign for production corresponding to the prize mode determined by the lottery of said random number generation part, and displaying this indicator to the view of a player.

8. The reel type game machine according to claim 6, wherein the transparent area of a non-sign positioned in said display window at the time of a game start and two or more kinds of said sign for production which may appear in said display window after a game start are given to the perimeter of said outside reel, respectively.

9. The reel type game machine according to claim 6, wherein two or more kinds of said sign for production constitutes an indication of one prize mode from a combination of two or more said outside reels arranged in parallel.

10. The reel type game machine according to claim 6, wherein the indicator meaning a high dividend and the indicator meaning a low dividend are contained in said inside of two or more kinds of said sign for production.
